(19) United States
(12) Patent Application Publication
(10) Pub. No.: US 2020/0328848 A1
(43) Pub. Date: Oct. 15, 2020

(54) TRANSPORT BLOCK DECODING OPERATION FOR HYBRID TRANSMISSION TIME INTERVAL (TTI) LENGTHS IN WIRELESS COMMUNICATION SYSTEMS

(71) Applicant: Intel IP Corporation, Santa Clara, CA (US)

(72) Inventors: Hong He, Sunnyvale, CA (US); Alexei Davydov, Nizhny Novgorod (RU); Gang Xiong, Portland, OR (US); Hwan-Joon Kwon, Portland, OR (US); Jie Cui, Santa Clara, CA (US); Debdeep Chatterjee, San Jose, CA (US); Ajit Nimbalker, Fremont, CA (US); Joonyoung Cho, Portland, OR (US); Dae Won Lee, Portland, OR (US)

(21) Appl. No.: 16/497,484

(22) PCT Filed: Apr. 27, 2018
(86) PCT No.: PCT/US18/29878

§ 371 Date: Sep. 25, 2019

Related U.S. Application Data
(60) Provisional application No. 62/491,093, filed on Apr. 27, 2017.
(60) Provisional application No. 62/501,309, filed on May 4, 2017.

(51) Int. Cl. H04L 1/18; H04L 1/16; H04W 72/04; H04W 76/27; H04L 5/00

(52) U.S. Cl. CPC H04L 1/1812; H04L 1/1614; H04L 1/1854; H04L 5/0055; H04W 72/042; H04W 76/27; H04L 1/1858

(57) ABSTRACT

Methods and architectures to reduce latency in next generation wireless networks such as LTE and/or new radio (NR), includes adjusting hybrid automatic repeat request (HARQ) techniques to selectively skip acknowledgements (ACKs) in various embodiments, and to configure one or more code block groups (CBG) designating code blocks for retransmission according to a code block group index bitmap present in received downlink control information (DCI).

### CROSS-REFERENCE TO RELATED APPLICATIONS

This application claims benefit of priority under 35 U.S.C. 119(e) to co-pending U.S. Application Ser. No. 62/491,093, filed Apr. 27, 2017 under the same title as the subject application, and U.S. Application Ser. No. 62/501,309, filed May 4, 2017 titled “Downlink Control Information And Hybrid Automatic Repeat Request-Acknowledgement Design For Code Block Group Based Transmission” both of which are incorporated herein by their reference.

### BACKGROUND

Embodiments of the present invention relate generally to wireless communications, and more particularly, but not limited to, new types of communication formats and protocols for use in next generation wireless networks.

Ongoing efforts to develop next generation wireless networks, such as 3GPP LTE, have resulted in an ever increasing complexity of solutions to support capacity of the growing number of worldwide users, data demands and usage models. New Radio (NR) brings wireless capabilities to a vast variety of new applications and devices and must be compatible with LTE standards for certain types of communications.

Hybrid automatic repeat request (hybrid ARQ or HARQ) is a combination of high-rate forward error-correcting coding and ARQ error-control. In standard ARQ, redundant bits are added to data to be transmitted using an error-detecting (ED) code such as a cyclic redundancy check (CRC). Receivers detecting a corrupted message will request a new message from the sender. In Hybrid ARQ, the original data is encoded with a forward error correction (FEC) code, and the parity bits are either immediately sent along with the message or only transmitted upon request when a receiver detects an erroneous message. Data from the data link layer or medium access control (MAC) layer is provided at the physical layer in an LTE system in segments referred as transport block (TB). In a single antenna transmission mode, one TB is generated for each transmission time interval. The transport block size is decided by the number of Physical Resource Blocks (NPRB) and the MCS (Modulation and Coding Scheme).

LTE-Advanced (LTE-A) Rel. 15, recently provided the ability to scale the transmission time interval (TTI) of UL/DL LTE radio frames between the legacy 1 ms subframe length TTI, and lessor duration TTIs, referred to as “shortened” or “subslot” TTIs (sTTls), in which to send data in transport blocks in the LTE physical layer frames/subframes. A transport block (TB) is divided into smaller size code blocks (CBs) in LTE, which is referred as code block segmentation before being applied to the channel coding/rate matching modules in the LTE physical layer.

Shortening the transmission time interval may have impact of various latency requirements in LTE. Particularly regarding HARQ processing for sTTI lengths having 2-symbol and 1-subslot configuration. Combining these improvements in an efficient, workable and backward compatible manner is challenging and requires further advancements. Specifically, a precise manner of handling hybrid automatic repeat requests (HARQ) for a variety of different TTI durations is needed.

### BRIEF DESCRIPTION OF THE DRAWINGS

Certain circuits, logic operation, apparatuses and/or methods will be described by way of non-limiting example only, in reference to the appended Drawing Figures in which:

FIG. 1 shows a simplified diagram of a wireless communications with selective skip-decoding according to various embodiments of the invention;

FIG. 2 shows a diagram of communications between a UE and eNB/gNB and another embodiment for skipping HARQ procedures according to various inventive aspects;

FIG. 3 shows an example diagram of a method for time-window-based HARQ selective decoding with hybrid transmission time-interval (TTI) lengths;

FIG. 4 shows a diagram of example signaling for dynamic RS position indication according to certain example embodiments of the invention;

FIG. 5 shows a diagram of a method for skip-decoding of HARQ messaging according to other embodiments of the invention;

FIG. 6 is a block diagram illustrating a sample coding index for downlink control information to provide code block group information to transmitting devices;

FIGS. 7-11 show various embodiments of bitmap indexing of code block groups (CBGs) use in a 5G New Radio wireless network; and

FIG. 12 shows an example block diagram of a wireless device such as user equipment (UE) adapted to perform certain functions and features of various embodiments of the disclosure.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the aspects of the various embodiments may be practiced in other examples that depart from the specific details discussed herein. In certain instances, descriptions of well-known devices, circuits, and methods are omitted so as not to obscure the description of the various embodiments with unnecessary detail.

The LTE radio frame has a length of 10 ms, and is divided into ten equally sized subframes (n) of 1 ms in length, which consist of 14 OFDM symbols each. Scheduling transmissions is done on a subframe basis for both the downlink and uplink. In FDD mode, each legacy (i.e., R8/R9) subframe consists of two equally sized slots of 0.5 ms in length for maximum number of 20 slots in a frame. Each slot in turn consists of a number of OFDM symbols for data transmission, which can be either seven (normal cyclic prefix) or six (extended cyclic prefix). 3GPP TS 36.211 v.15.0.0 (2017-12), which is fully incorporated herein by its reference, referred to as “Release 15” or R15, LTE further defines the physical layer Type 1 Frame (FDD mode) as a 10 ms radio frame having 10 subframes, 20 slots, or now, additionally, up to 60 subslots are available for scheduling downlink transmissions and the same for uplink transmissions in each 10 ms radio frame.

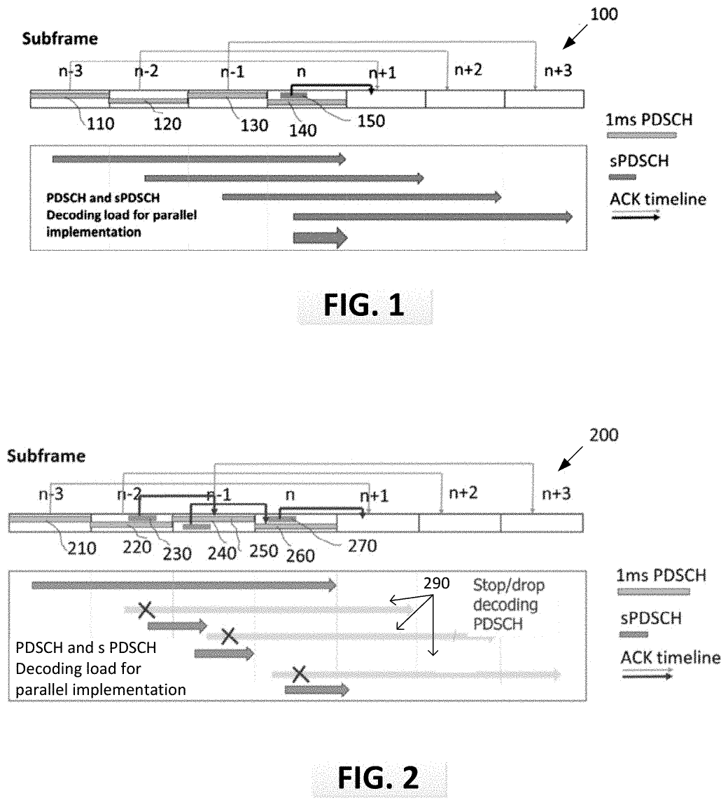

A transmission time interval (TTI) relates to encapsulation of data from higher layers, i.e., a MAC PDU or segmented MPDU, into subframes for transmission on the radio link layer or physical (PHY) layer. Before R15, the TTI in a 1 ms subframe was LTEs smallest unit of time in which a network access station, e.g., FIG. 1 eNB 125 is capable of scheduling UE 110 for uplink or downlink transmissions. If UE 110 is receiving downlink data, then during each 1 ms subframe, eNB 125 will assign resources and inform user where to look for its downlink data through indexing in the physical downlink control channel (PDCCH) channel. To combat errors due to fading and interference on the radio link, data is divided at the transmitter into transport blocks and then the bits within a block are encoded and interleaved. The length of time required to transmit one such transport block is the TTI. In legacy LTE, the TTI is a 1 ms subframe.

As mentioned before, LTE R15, referred to as Gigabit LTE, has provided a new capability for a scalable duration TTI including the ability to schedule a “shortened” or “subslot” transmission time interval (“sTTI”) using between as few as 2 OFDM symbols (i.e., 7 subslots in each 1 ms subframe), up to 7 OFDM symbols to make reception and transmission more efficient with hybrid automatic repeat request (HARQ) error detection and correction.

Packet data latency is a key performance metric for wireless communication systems such as LTE to improve the user experience. Packet data latency is important not only for the perceived responsiveness of the system; it is also a parameter that influences the throughput. HTTP/TCP is the dominating application and transport layer protocol suite used on the Internet today. 3GPP has adopted the shortened TTI to help improve the packet data latencies of the LTE system. As of LTE Release 15, the turnaround time for UE HARQ acknowledgement (HARQ-ACK) for a 1 ms TTI is 4 ms.

Referring to FIG. 1, the UE may transmit a positive or native ACK in subframe n+4 if the physical downlink control channel (PDCCH) and physical downlink shared channel (PDSCH) are transmitted to a UE in subframe n. For a parallel PDSCH decoding architecture this requirement translates into implementation of 4 PDSCH decoding blocks, where each block should be capable of decoding one PDSCH with 1-2 transport blocks (TBs) per 4 ms or 3 ms, as illustrated. The HARQ-ACK timeline for a shortened TTI in the physical downlink shared channel or “sPDSCH” 150 needs to be significantly reduced compared to legacy 1 ms TTI so reduced latency benefits may be realized. Accordingly, decoding the shortened sPDSCH 150 has to be started once it is received and cannot be pipelined like the 1 ms PDSCH processing 110-140.

For shortened TTI (sTTI) communication in LTE, it was decided that a UE can be dynamically (with a subframe to subframe granularity) scheduled with legacy 1 ms TTI unicast PDSCH 110-140 and/or sTTI unicast PDSCH 150, as illustrated in FIG. 1. Due to quite different processing time requirements, handling the processing of unicast PDSCHs and sPDSCH with different TTI lengths become very challenging especially taking into account a limited UE processing capability.

According to certain embodiments, the difficulties of the above-mentioned transport block decoding problems for sPDSCH and PDSCH are avoided and a lower latency may be realized without hardware modification or increasing the cost of device. In certain embodiments, this may be achieved by s-PDCCH operations that can selectively skip decoding all or part of a PDSCH with a longer TTI length within a decoding time window basin, at least on the sum of transport block sizes (TBSs) received. Additional embodiments of the present disclosure may dynamically signal the reference signal (RS) configuration to minimize the RS overhead with full flexibility. The RS configuration includes both location and density in a sTTI. Yet further embodiments of the present disclosure enable timing advance (TA)-dependent HARQ-ACK timeline and PUSCH scheduling timeline determinations.

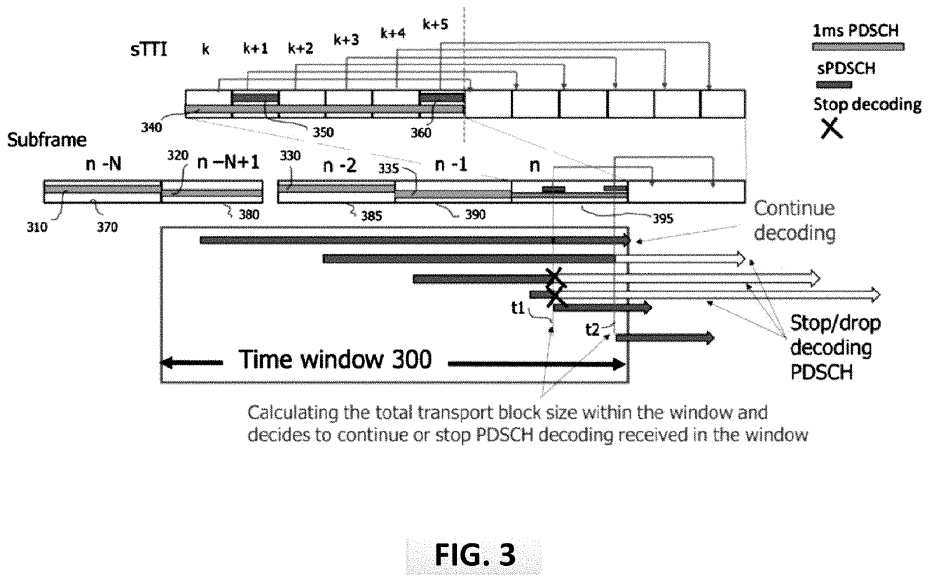

Referring to FIG. 2, according to one embodiment of the present invention, a method 200 for reporting UE capability of simultaneously decoding sPDSCH and PDSCH in a single DL subframe in a band agnostic manner field is provided by defining a dedicated information element (IE). In particular, if the UE indicates support of simultaneous sPDSCH and PDSCH reception within a component carrier in a single 1 ms TTI, the UE may decode the PDSCH in addition to sPDSCH in a 1 ms subframe and also provide an HARQ-ACK for both PDSCH and sPDSCH(s). Otherwise, the UE may decode the sPDSCH and is not required to decode PDSCH received in a same subframe. For HARQ-ACK generation, the UE may provide the HARQ-ACK for sPDSCH subject to the decoding result, but may feedback a non-acknowlegement “NACK” only for PDSCH.

As shown, in FIG. 2, UE #1 indicates using the simultaneous sPDSCH/PDSCH information element (IE) that it is not capable of simultaneous sPDSCH/PDSCH in a single 1 ms TTI. Then, UE #1 may stop or skip decoding of PDSCH 220/250/260 and set “NACK” for HARQ-ACK feedback correspondingly, upon receipt of the sPDSCH 230/240/270 in subframe n−2, n−1 and n, respectively. According to other embodiments sPDSCH/PDSCH decoding enhancements are provided by leveraging the earlier stop or skip decoding PDSCH(s) or sPDSCH(s) 290 e.g. 220 and 230 in FIG. 2 within a determined data decoding time window to minimize the impact upon HARQ processing of PDSCH.

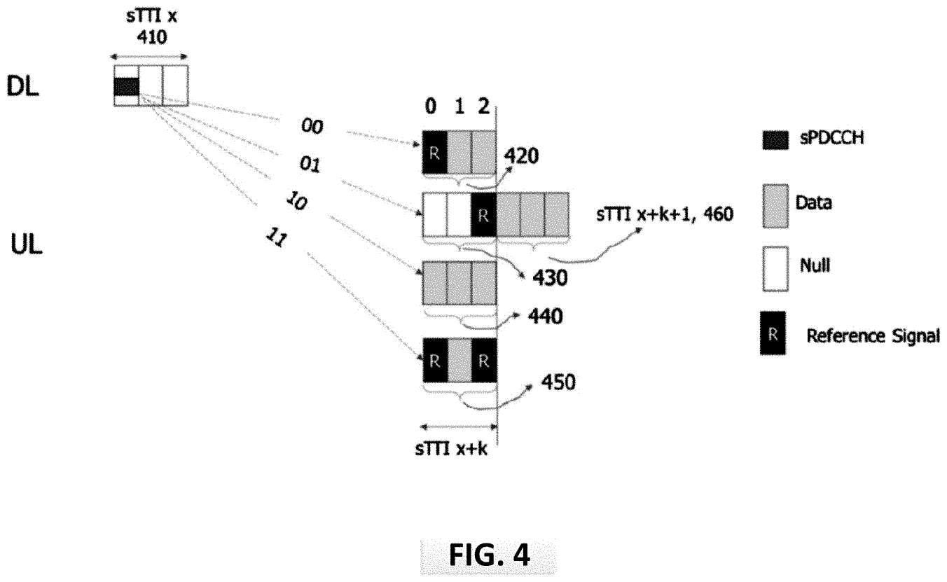

In some designs, referring to FIG. 3, a method 300 for time-window-based decoding techniques provide a dynamic PDSCH/sPDSCH decoding determination i.e. continue decoding or stop (referred to as “skip decoding”) for the PDSCHs 310-340 scheduled in multiple subframes of a time window 300, which ends at the subframe n that contains a respective sPDSCH 350 or 360. Assume for subframe/slot n, for example, time-domain decoding window (e.g. time-window 300 of FIG. 3) of size N comprising subframe/slot n to subframe/slot m (represented as subframes 380-395). In a FDD system, there subframes or slots may be consecutive, such as subframe n, n−1 . . . n+N−1. However, for a time division duplex (TDD) system, these subframes or slots may not be consecutive in time, since not every subframe/slot is a downlink subframe.

Embodiments may additionally or alternatively provide restrictions with respect to the size of the time-domain decoding window 300. For example, the size of a time-domain decoding window used with respect to a particular channel e.g. sPDSCH, may be restricted based on the decoding delay or time budget for a given channel, e.g. PDSCH. Accordingly, the size of the time-domain decoding window 300 of embodiments may be fixed (e.g. N=4 or 3 ms for FDD mode), semi-statically configurable (e.g. configured via Radio Resource Control (RRC)), and/or dynamically indicated via PDCCH channel subject to the latency requirement. Where time-domain decoding window sizes are configurable, a PDCCH or other control channel may provide information indicating the particular time-domain decoding window size selected. In some embodiments herein, different time-domain decoding window size may be applied for different respective PDSCH TTI length when more than two TTI lengths are configured for a given UE for PDSCH receptions.

In one embodiment, the maximum total transport block size (TBS) for DL-SCH channels within a time domain decoding window may be specified as, MAX_TBS_{TW} and may be limited as, a function of the TTI length used for DL-SCHs transmission. For example, for 1 ms subframe or a reference TTI length, the maximum transport block size (Max_TBS) may be expressed as equation (1):

MAX_TBS_{ref}=Cₘₐₓ (1)

For a sTTI that requires a faster processing and low latency, the effective transport block for C-bit TBS received in sTTI subslot (k) may be given as equation (2):

TBS_{eff}=TBS_{sTTI}*x (2)

In equation 1 and 2, Cₘₐₓ is the maximum transport block size allowed or indicated by the UE category. Parameter x may be chosen being greater than one. In particular, the parameter x may be selected based on various factors, such as, the new control region sPDCCH decoding time and particularly the sTTI numbers within a reference TTI length e.g. 1 ms. Then, the maximum transport block size within a decoding window 300 of FIG. 3 in time domain comprising subframe n, n−1, . . . n−N+1 may be expressed as:

MAX_TBS_{TW,n}=Cₘₐₓ*N

If the UE is configured with PDSCH receptions with more than one TTI length, e.g. 1 ms TTI and an sTTI, the UE needs to calculate the sum of the size of TBs received within the decoding time window of one subframe and compare it against a TBS threshold once detection of the sPDSCH occurs. The TBS threshold imposed by a UE can be UE-category dependent.

In some designs, for a sPDSCH indicated by the detection of a corresponding sPDCCH in sTTI k of a subframe n, the UE may decode the sPDSCH if the total TBS, i.e. TBS_{TW,n,k} within the time window n does not exceed the MAX_TBS_{TW,n}, wherein the TBS_{TW,n} is given in equation (3) as follows:

$${TBS}_{TW , n , k} = {\sum }_{i = n - N 1 + 1}^{n} {TBS}_{i , TTl - 1} + {\sum }_{j = k - N 2 + 1}^{k} {TBS}_{, TTl - 2} \qquad ( 3 )$$

Wherein the value of N1 and N2 for TTI length type 1 (i.e. TTI-1 in Eq.3) and type 2 (i.e. TTI-2 in Eq.3) may be determined by its respective processing time of PDSCH using TTI type 1 or type 2 or their corresponding HARQ timelines. In particular, N1=4 for 1 ms TTI in an FDD system and N2=6 for a 2-symbol sTTI. Otherwise, the UE may drop or stop or skip decoding one or multiple PDSCH scheduled in the earlier subframes until the total TBS_{TW,n,k} does not exceed the MAX_TBS_{TW,n}. Correspondingly, the UE provides the “NACK” for the PDSCH that stops decoding or skip decoding.

FIG. 3 provides an embodiment in accordance to this design where if the total TBS TBS_{TW,n,k+1} in sTTI k+1 exceeds the maximum TBS MAX_TBS_{TW,n}, the UE may stop or skip decoding of the PDSCH 335 and 340 that are transmitted with 1 ms TTI in subframe n and n−1 respectively, so as to get the processing capability for the decoding of sPDSCH 350 received in sTTI k+1 of subframe n to have a reduced latency desired. Further, the UE may stop or skip the decoding of the PDSCH 330 that is scheduled with 1 ms TTI in subframe n−2 385, due to again the total TBS TBS_{TW,n,k+5} exceeds the maximum TBS MAX_TBS_{TW,n}. It should be noted that the TBS_{i,TTI-1} for PDSCH 335 and 340 should be set as ‘0’ in calculating the TBS_{TW,n,k+5} because they have been stopped for decoding at the earlier time instance t1, i.e. sTTI k+1 as illustrated in FIG. 3.

According to other embodiments of the invention, the Reference Signal (RS) configuration and its associated sPUSCH transmission may be indicated by one field in the downlink control information (DCI) format. The RS configuration may comprise a variety of information including how many RSs and where in a data transmission they are located. In some designs, a number of RS configurations or patterns may be predefined in specification which is suitable to be used for the RS sharing among multiple sTTls within a slot. The DCI format may be further used to dynamically select and indicate one predefined RS pattern out of those predefined RS configurations to a given UE.

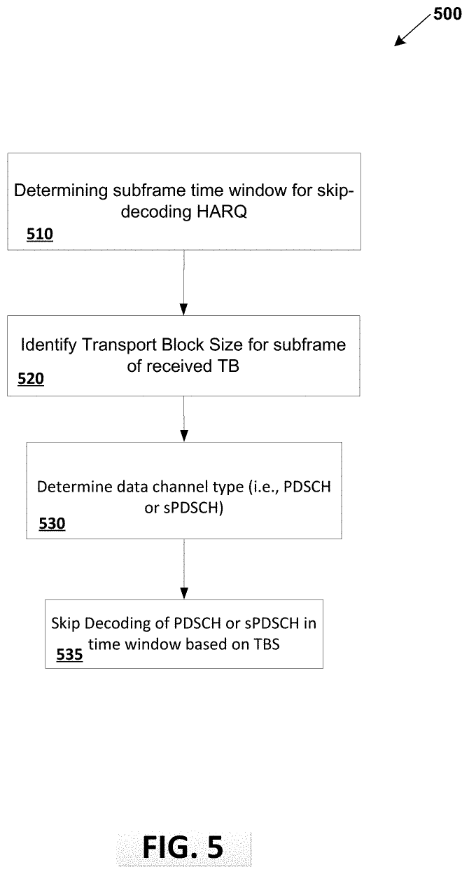

Referring to FIG. 4 and the table below, an example of four reference signal (RS) patterns in terms of location and RS numbers in an sTTI, i.e. 420-450, may be predefined. In certain preferred embodiments, each RS pattern should be identified by a dedicated index i.e. “RS location indicator” (RSIF) information field, which is transmitted as part of DCI format as shown in the example Table I below:

TABLE I

| Value of ‘RS | | |
|---|---|---|
| location | | |
| indicator’ | RS pattern | Description |
| ‘00’ | RS pattern 420 | RS and sPUSCH are transmitted in a |
| | | same sTTI with RS in the 1^{st} symbol. |
| ‘01’ | RS pattern 430 | RS and its associated sPUSCH are |
| | | transmitted in different sTTIs, |
| | | where RS is located in the last |
| | | symbol of sTTI 430 and sPUSCH is |
| | | transmitted in a consecutive later |
| | | sTTI 460. |
| ‘10’ | RS pattern 440 | sPUSCH only is transmitted in a sTTI |
| | | without RS, assuming RS is transmitted |
| | | in an earlier sTTI of a same subframe |
| ‘11’ | RS pattern 450 | RS and sPUSCH are transmitted in a |
| | | same sTTI with RS in the 1^{st} and last |
| | | symbol. |

It is worthy of noting that there is no data transmission in sTTI 430. Assuming a fixed scheduling timeline for sPUSCH transmission was predefined for sTTI operation, two DCI formats, i.e. one DCI format in sTTI x 410 and the other in sTTI x+1, may be used to separately schedule an RS only transmission in sTTI x+k 430 and the corresponding sPUSCH transmission in sTTI x+k+1 440.

As shown in FIG. 4, a UE shall, upon detection of a sPDCCH in sTTI x intended for the UE, adjust the corresponding sPUSCH and associated RS transmission in sTTI x+k according to the sPDCCH information. In various embodiments, different k values may be predefined in the specification, preferably, based at least in part, on a respective maximum timing advance (TA) value. In one embodiment, a larger processing time ‘k1’ for HARQ-ACK feedback of sPDSCH and sPUSCH scheduling may be defined when a maximum timing advance value is T1, while a smaller processing time ‘k2’ may be defined when a maximum timing advance value is T2, where T1>T2; aAs one example, k1=6 for T1 and k2=4 for T2.

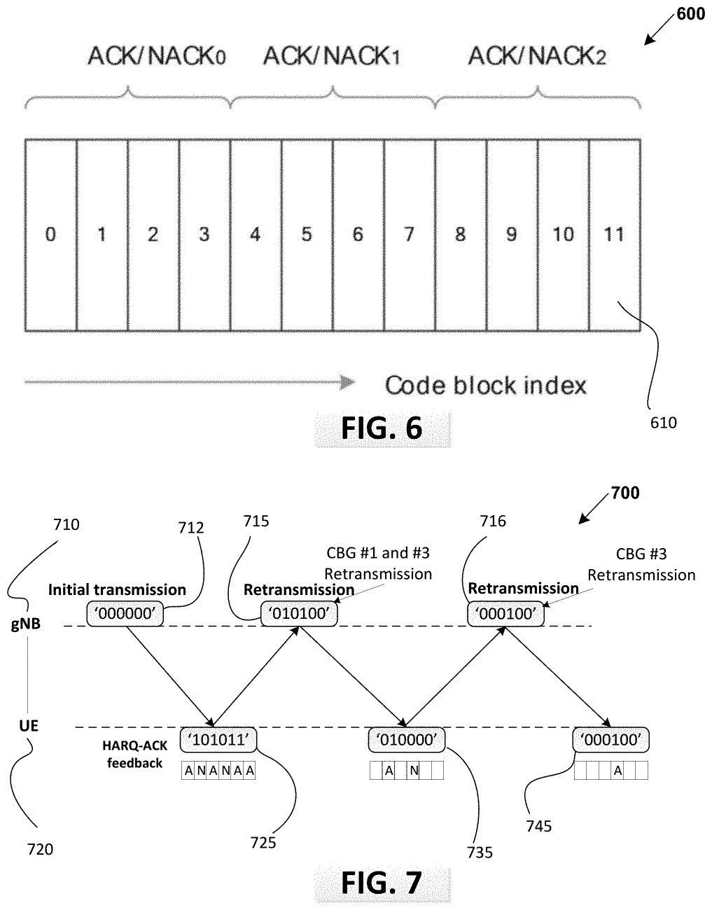

Turning to FIG. 5, a block diagram of a method 500 for reducing latency in wireless communications having variable size transmission time intervals (TTIs) may include a user equipment: determining 510 a time window for a respective subframe; receiving one or more transport blocks within the said subframe; and 535 selecting to perform skip-decoding of at least one transport block (TB) of the one or more transport blocks received in the said time window based, at least in part, on a data channel type 530 and total transport block size (TBS) 520.

In certain embodiments, the data channel type 530 comprises one of a Physical Downlink Shared Channel (PDSCH) using a 1 ms Transmission Time Interval (TTI) length; and a shortened PDSCH (sPDSCH) using a shortened TTI (sTTI) having fewer OFDM symbols than the 1 ms TTI. In some embodiments, the UE selects to perform the skip-decoding one PDSCH channel when the received data channel type in the subframe comprises the sPDSCH and the UE selects to not perform the skip-decoding when the data channel type in the subframe comprises the PDSCH transmission.

In this embodiment, the UE may be configured to monitor 530 for the sPDSCH and PDSCH to determine whether to perform skip-decoding. In certain embodiments, skip-decoding is further performed based, at least in part, on whether a total a transport block size (TBS) of PDSCH and sPDSCH received by the UE in the time window exceeds 520 a TBS maximum threshold.

According to some embodiments, the skip-decoding 535 comprises one or more of: delaying a hybrid automatic repeat request (HARQ) acknowledgement (ACK) decision or set “NACK”; skipping all decoding of the one or more transport blocks; and attempting to decode the one or more transport blocks using a best-efforts approach.

In some embodiments, performing a HARQ-ACK timing or sPUSCH scheduling timing determination is based, at least part, on a maximum timing advance (TA) threshold. Moreover, a larger HARQ-ACK timing or sPUSCH scheduling timing is used if the maximum TA value is up to a predefined value T1, and a smaller HARQ-ACK timing or sPUSCH scheduling timing is used if the maximum TA value is up to a predefine value T2, where T1>T2.

The time window size may be determined, at least in part, based on the HARQ-ACK timeline of the PDSCH channel with a longer TTI length. Furthermore, the UE may determine whether to individually apply a skip-decoding decision to a respective PDSCH based on the scheduling subframe within the decoding window. Lastly, the UE may perform soft buffer management by storing soft bits received in the subframe in which UE skipped PDSCH decoding within the time window.

HARQ of Code Block Groups in New Radio (NR) Configurations

For NR, higher data rates will continue to be a key driver in network development and evolution for 5G system. It is envisioned a peak data rate of more than 10 Gps and a minimum guaranteed user data rate of at least 100 Mbps should be supported for a NR system. To support the higher data rate for NR, a larger system bandwidth is needed, especially for carrier frequencies above 6 GHz including cmWave or mmWave system. In these example embodiments, it is expected that a large number of code blocks for one transport block would be transmitted in one slot for either Turbo code or LDPC code due to large system bandwidth, high MIMO order or high modulation order.

In the existing LTE specification, one bit hybrid automatic repeat request-acknowledgement (HARQ-ACK) is used to indicate whether one transport block (TB) is successfully decoded. Given that a large number of code blocks would be supported in NR, one bit HARQ-ACK feedback for one transport block may not be desirable, especially when considering the retransmission. In the case a receiver fails to decode the transport block and feeds back NACK to the transmitter, the transmitter would retransmit the whole transport block which would consume substantial amount of resources for retransmission.

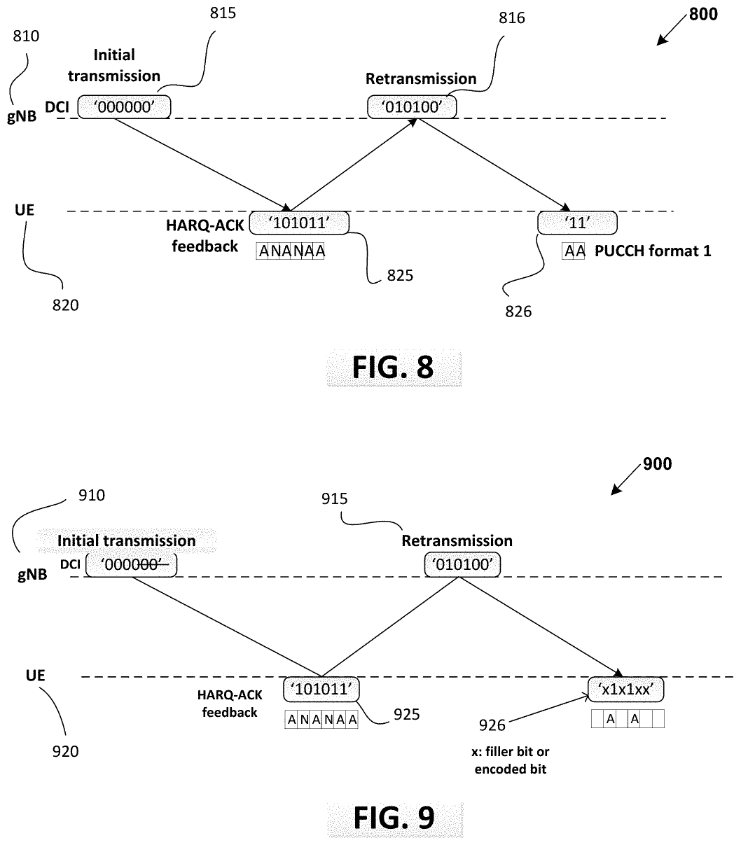

For 5G or New Radio, a code block group (CBG) based retransmission is supported where the UE may report HARQ-ACK feedback with finer granularity on failed CBGs. FIG. 6 illustrates one example representation 600 of CBG based HARQ-ACK feedback. In this example, one transport block includes 12-code blocks 610 and a bundled size for HARQ-ACK feedback is ‘4’. In this case, ‘3’ HARQ-ACK bits are used to indicate whether ‘3’ CBGs are successfully decoded and where each CBG contains ‘4’ code blocks.

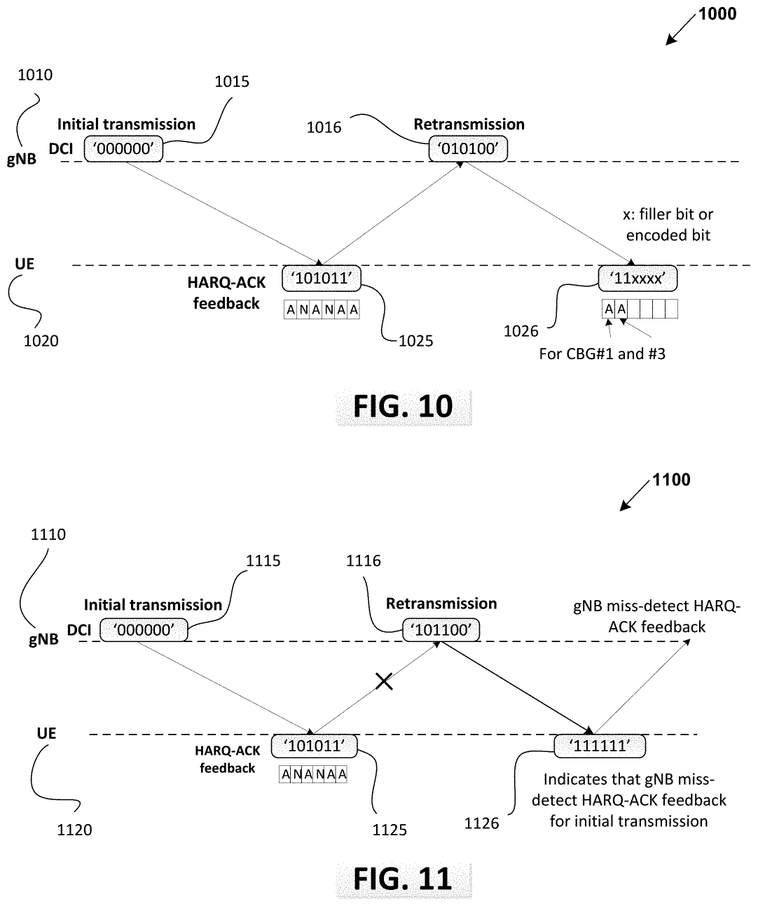

Referring to FIG. 7, when a NR NodeB (gNB) base station 710 receives the code block (CB) or code block group (CBG) specific HARQ-ACK feedback 725 from UE 720, it can schedule the retransmission 715 of the CBGs which the UE 720 fails to decode successfully. For proper operation, the UE 720 needs to be informed of the CBG index for retransmission. After correctly decoding the CBGs in retransmission 715. 716, the UE 720 can concatenate all the CBGs and deliver the transport block to the higher layer. Certain mechanisms should therefore be defined to signal the CBG index for retransmission.

Embodiments disclosed herein may include a downlink control information (DCI) and HARQ-ACK feedback design for CBG-based initial transmission and retransmission for NR. In particular, various embodiments may include:
Options for CBG construction from CBs of a transport block (TB);
DCI design for CBG-based initial transmission/retransmission; and/or
HARQ-ACK design for CBG based initial transmission/retransmission

CBG Construction

The grouping of CBs corresponding to a TB into CBGs can be realized in various ways including, as specified by 3GPP, but not limited to:

Option I: With a configured number of CBGs, the number of CBs in a CBG changes according to the transport block size (TBS). For further study (FFS) by 3GPP is when the CBs are less than the configured number of CBGs.

Option 2: With a configured number of CBs per CBG, the number of CBGs changes according to the TBS.

Option 3: The number of CBGs and/or the number CBs per CBG are defined according to the TBS. FFS for the case of retransmission, details on each option, and CBG aligned with symbols, etc.

In accordance with the foregoing options, CB construction options according to various embodiments are disclosed as follows. In some embodiments, the maximum number of CBGs (N) may be configured via radio resource control (RRC) signaling in a UE-specific or cell-specific manner or as predefined in the standards specifications. In some embodiments, the actual number of CBGs used to transmit a TB may be indicated by the eNB or gNB explicitly, via DCI scheduling of the initial transmission 712 using, e.g., a bitmap of length ‘N’ as described in more detail below. This can address the scenario wherein the number of CBs is less than the configured maximum number of CBGs as mentioned for 3GPP's future further study above. Furthermore, various embodiments may provide flexibility to the gNB to determine the optimal number of CBGs that may be used to convey the TB. This can enable the gNB to schedule transmissions such that the CBGs are approximately aligned to the symbol(s), i.e., approximately aligned to symbol boundaries.

Given a number of CBs, which for example, can be determined from the TBS value, and an indicated number of CBGs used signaled, for example, via a bitmap in the DCI, the grouping of CBs to CBGs can be performed to realize a relatively uniform distribution. That is, for N_{CBG} (<N) CBGs and M CBs, each CBG contains at least floor (M/N_{CBG}) CBs, with the remaining M−N*floor(M/N_{CBG}) CBs distributed in relative uniformity over the first M−N*floor(M/N_{CBG}) CBGs. However, the indexing of CBs into CBGs may be done in a specific order, i.e., the CBs 610 may be indexed in ascending order from the first through the last CBG as shown in FIG. 6.

In other embodiments, the number of CBGs may be configured, and for all TBs with a number of CBs larger than the number of configured CBGs, the CBs may be grouped into the configured number of CBGs. For cases where the number of CBs is smaller than the number of CBGs, only a single CBG may be used and this may be determined, for example, by the UE implicitly using the transport block size (TBS) value. When the number of CBs is greater than or equal to the number of CBGs, the grouping may be done such that the distribution of CBs to the CBGs is as uniform as possible as described for the previous approach.

For embodiments related to a substantially uniform grouping approach, at the cost of reduced flexibility, the CB-to-CBG grouping can be determined by the UE based on the number of CBs, as derived from the TBS value, and the number of transmitted CBGs need not be indicated to the UE via dynamic layer I signaling for initial transmission. For such embodiments, the functionality of a new data indicator (NDI) field in the DCI may be implemented by assigning a particular CBG bitmap code-point to indicate an initial transmission. For retransmissions, the CBG bitmap (described in greater detail below) may need to be transmitted.

DCI Design for CBG Based Transmission/Retransmission for NR

In various embodiments for DCI scheduling CBG based retransmission, a bitmap may be included in the DCI, with each bit in the bitmap that may indicate whether CBG is retransmitted. For instance, bit ‘1’ may indicate that CBG is retransmitted and bit 0 may indicate that CBG is not retransmitted.

In other embodiments, a field can be included in the DCI, where higher layer configuration may associate each state of the field with a particular set of CBG(s), and may indicate whether the corresponding CBG(s) is transmitted or not. The field may also be used to indicate other information in the DCI such as NDI, Redundancy version, or resource allocation, etc. For example, a single field may be used to indicate CBG transmission as well as certain other information such as redundancy version or resource allocation, etc.

In certain embodiments, for DCI scheduling an initial data transmission, the bitmap may not be included. To reduce the number of blind decodings at UE side, zero padding can be inserted to match the size of DCI of initial transmission/retransmission of entire TB with the size of DCI for CBG-based retransmission (i.e. bitmap for scheduling of data retransmission). If the blind decode attempts for CBG-based retransmissions are separately budgeted (or configured, for example, via a different CORESET), then zero padding may not be required.

In some embodiments, the DCI for CBG-based retransmission could be separately designed, with certain fields derived from an earlier DCI for the same TB. For example, the following Table 2 shows a possible DCI format size, where the modulation and coding scheme (MCS)/TBS for a CBG-based retransmission could be derived from an earlier transmission, and the redundancy version for a CBG-based DCI could be fixed (e.g. to RVO), or determined based on other factors such as retransmission number, etc. With such a scheme, the DCI payload sizes can be made roughly similar without requiring a lot of zero-padding.

TABLE 2

| | TB-based DCI | CBG-based DCI |
|---|---|---|
| TB-or-CBG-based DCI ? | 1 | 1 |
| MCS | 5 | 0 |
| Resource Allocation | 25 | 25 |
| HARQ ID | 4 | 4 |
| CBG index1 | 0 | 8 |
| NDI1 | 1 | 1 |
| RV1 | 2 | 0 |
| TPC | 2 | 2 |
| CSI request | 1 | 1 |
| SRS request | 1 | 1 |
| DAI | 2 | 2 |
| ARI | 2 | 2 |
| CRC | 16 | 16 |
| Total | 62 | 63 |

Alternatively, in some embodiments a bitmap with fixed filler bits can be included in the DCI in scheduling initial data transmission. This can help maintain same DCI size for scheduling initial data transmission and retransmission, thereby reducing UE blind decoding attempts. This may also allow the UE to perform sanity check to improve the reliability of physical downlink control channel (PDCCH) decoding. For instance, the bitmap with all “1” or all “0”'s can be included in the DCI for initial data transmission.

In one embodiment of the invention, a maximum number of CBGs, i.e., N can be predefined in the specification or configured by higher layers via NR master information block (MIB), NR remaining master information block (MMIB), NR system information block (SIB) or radio resource control (RRC) signaling/MAC signaling. To dynamically indicate the actual scheduled number of CBGs for DL and UL data transmission, a bitmap with size N can be included in the DCI scheduling initial data transmission. More specifically, the number of “0” or “1”'s in the bitmap can indicate the number of CBGs actually scheduled for data transmission. In an example, a bitmap with a predefined state may indicate that TB based transmission is employed for initial data transmission. As another alternative, the size of the bitmap can be fixed in the specifications to the maximum value of N (Nmax) supported by specifications and only the first N bits in the bitmap are used to covey the information on the transmitted CBGs. This can avoid the DCI size variation for different values of N, and the remaining bits in the bitmap may be considered as padding bits at the “DCI field”-level, or even be jointly encoded to convey some other information depending on the configuration.

In various embodiments, assuming that N=6, i.e., ‘6’ CBGs are configured by higher layers, a bitmap of “111100” may be included in the DCI scheduling an initial data transmission. This indicates that ‘4’ CBGs are actually scheduled for initial data transmission. Further, a bitmap “100000” may indicate TB based transmission is employed for initial data transmission.

Certain embodiments may also pertain to the case when the number of code blocks (CB) is less than the number of CBGs. In particular, the number of CBGs can be predefined in the specification or configured by higher layers via NR MIB, NR MMIB, NR SIB or RRC or MAC signaling. Here, a bitmap with size N can be included in the DCI scheduling initial data transmission, where the number of “1” or “0”'s can indicate the actually scheduled number of CBGs for data transmission. Further, for this option, in the DCI scheduling CBG based data retransmission, the bitmap size may be determined according to the number of actual scheduled CBGs for initial transmission or the number of CBs in case when the number of CBs is less than the number of CBGs.

In embodiments, bit order of the bitmap in the DCI may indicate the CBG index for retransmission. The bit ordering of bitmap in the DCI scheduling retransmission can follow that in the DCI scheduling initial transmission. FIG. 7 illustrates one example method 700 of bit ordering in a bitmap used in the DCI scheduling retransmission. In the example, the bit ordering for CBG index in retransmission remains the same in the DCI for scheduling retransmission.

In another embodiment, a new data indicator (NDI) may not toggled during CBG based retransmission. In embodiments when NDI may be toggled in the DCI, a new data transmission may be scheduled. That bitmap with predefined state in the DCI scheduling CBG based transmission and retransmission may be used to indicate whether this is new transmission. In this case, the NDI field may not be needed, which can help reduce DCI overhead. In one example, a bitmap with state “111111” can be used to indicate the scheduling of new data transmission.

In certain embodiments, a bitmap with an inverse state of bitmap in DCI scheduling initial transmission can be used to indicate the new data transmission. A DCI design for CBG-based HARQ operation may include a DCI field to indicate the cause of the CBGs retransmission to facilitate the soft combination at the UE. This may include to indicate whether it is due to the puncturing operation for the ultra reliable and low latency communications (URLLC) transmission by a gNB. This information is beneficial to assist the gNB for proper soft combining of the retransmitted CBGs. In an aspect, 1-bit may be used to indicate two values, which may be sufficient to indicate the presence of URLLC puncturing.

HARQ-ACK for CBG Based Initial Transmission/Retransmission for NR

In embodiments, the number of HARQ-ACK feedback bits may be determined according to the number of scheduled CBGs for both initial transmission and retransmission. In some embodiments when a UE can decode most of CBGs successfully and gNB may schedule the retransmission of a failed CBG, the number of HARQ-ACK feedback bits for retransmission can be reduced substantially, when considering a relatively large number of CBGs for data transmission.

Depending on exact HARQ-ACK feedback payload size, different physical uplink control channel (PUCCH) formats may be employed. Dynamic PUCCH format switching may help improve the link budget for PUCCH transmission.

FIG. 7 illustrates one example 700 of dynamic HARQ-ACK payload size and PUCCH format switching. In the example, ‘6’ CBGs are configured. For initial transmission, the UE 720 fails to decode 725 CBG #1 and #3. Subsequently, gNB 710 schedules 715 the retransmission of CBG #1 and #3.

For embodiments related to this example, the number of HARQ-ACK feedback bits may be reduced from ‘6’ (for initial transmission) to ‘2,’ which indicates that PUCCH format 1 may be employed.

In other embodiments, the number of HARQ-ACK feedback bits can be fixed during CBG based retransmission, which can be determined according to the number of CBGs which is configured by higher layers or the number of actually scheduled CBGs. Note that the number of actually scheduled CBGs can be indicated in the DCI scheduling initial transmission.

With regard to the bit position of HARQ-ACK feedback for retransmission, two sets of embodiments can be considered as follows:
Embodiment set 1: the bit ordering of HARQ-ACK feedback for CBG based retransmission follows the CBG index of bitmap in DCI scheduling retransmission.

In certain DCI formats, the gNB schedules the retransmission of the transport block and includes a CBG transmission information (CBGTI) field of bits, where the first bits of the CBGTI field for the transport block have a one-to-one mapping with the CBGs of the transport block. With this format, the UE may determine whether or not a CBG is retransmitted based on a corresponding value of the CBGTI field where a binary 0 indicates that a corresponding CBG is retransmitted and a binary 1 indicates that a corresponding CBG is not retransmitted.

FIG. 7 illustrates an example of HARQ-ACK feedback bit ordering for this option. In the example, bitmap “010100” is included in the DCI scheduling 715 CBG based retransmission, which indicates that CBG #1 and #3 are retransmitted. For embodiments related to this example 700, UE 720 would feedback 725 HARQ-ACK for CBG #1 and #3 in bit #1 and #3, respectively.
Embodiment set 2: the bit ordering of HARQ-ACK feedback for CBG based retransmission starts from the “1” bit. FIG. 8 illustrates one example 800 of HARQ-ACK feedback bit ordering for this option. In the example, bitmap “010100” is included in the DCI scheduling CBG based retransmission 816, which indicates that CBG #1 and #3 are retransmitted. For these embodiments, the UE 820 would feedback HARQ-ACK 826 for CBG #1 and #3 in bit #0 and #1, respectively.

Further, for the remaining bits in HARQ-ACK feedback for retransmission, filler bits or some encoding scheme may be applied to fill in the HARQ-ACK feedback. In one example, zero padding can be employed for filler bits. In case when encoding scheme is employed, extra protection can be provided to improve HARQ-ACK feedback performance. For instance, a simplex coding scheme or simple XOR operation can be used as the encoding scheme.

As mentioned previously, the number of HARQ-ACK feedback bits can be fixed for CBG based retransmission, as determined by the number of CBGs that are configured by higher layers. For example, if a UE is configured with a higher layer parameter HARQ-ACK-codebook=semi-static, the HARQ-ACK codebook includes the HARQ-ACK information bits and, if a CBG for a transport block is less than a maximum CBG, the UE may simply insert a NACK value for the last HARQ-ACK information bits less than the maximum value.

As shown in FIGS. 9 and 10, HARQ-ACK feedback 926, 1026 in “x” for retransmission can be considered as some filler bits or encoded bits. In other embodiments, referring to FIG. 11, some known state for HARQ-ACK feedback 1126 for CBG-based retransmission can be defined to indicate that gNB 1110 may miss-detect the HARQ-ACK feedback for initial transmission or previous retransmission. In one example, all “1” or all “0” bitmap can be defined for this purpose.

FIG. 11 illustrates this example of a known state in HARQ-ACK feedback to indicate that gNB 1110 miss-detect HARQ-ACK feedback for initial transmission. In embodiments, the UE 1120 may transmit 1125 HARQ-ACK feedback “101011” for initial transmission to indicate that CBG #1 and #3 are not successfully decoded. However, gNB 1110 may miss detect the HARQ-ACK feedback 1125 and it schedules the retransmission of CBG #0, #2 and #3. When UE 1120 decodes the PDCCH carrying DCI for retransmission 1116, it may identify that gNB 1110 miss-detected the HARQ-ACK 1125 for initial transmission. In this case, UE can feedback “111111” to indicate that gNB may miss-detect the HARQ-ACK feedback.

Alternatively, the UE 1120 may perform encoding of the CBG #3 which has been scheduled 1116 due to the misdetection of the HARQ-ACK from the UE 1120, in addition to the CBG #0 and #2 which may have failed in the initial decoding at the UE 1120. After completing the decoding, UE 1120 can indicate the decoding results for the CBG #0, #2 and #3 in the corresponding HARQ-ACK feedback.

In another option, UE 1120 may still use the same HARQ-ACK feedback in previous transmission in case when UE determines that gNB may miss-detect the HARQ-ACK. In this case, gNB may retransmit the correct CBGs in the subsequent transmissions.

In other embodiments, both semi-static and dynamic HARQ-ACK payload size determination can be supported for CBG based retransmission. Whether to employ semi-static or dynamic HARQ-ACK payload size determination can be configured by higher layers via NR MIB, NR MMIB, NR SIB or RRC signaling.

Alternatively, whether to employ semi-static or dynamic HARQ-ACK payload size determination can be determined according to the number of CBGs used for the data transmission. In case when the number of CBGs is less than a threshold, semi-static HARQ-ACK payload size determination can be employed; while in other embodiments when the number of CBGs is greater than or equal to a threshold, dynamic HARQ-ACK payload size determination can be employed. The threshold can be predefined in the specification or configured by higher layers via NR MIB, NR MMIB, NR SIB or RRC signaling.

In other embodiments, both semi-static and dynamic HARQ-ACK payload size determination can be supported for CBG based retransmission. Whether to employ semi-static or dynamic HARQ-ACK payload size determination can be configured by higher layers via NR MIB, NR MMIB, NR SIB or RRC signaling.

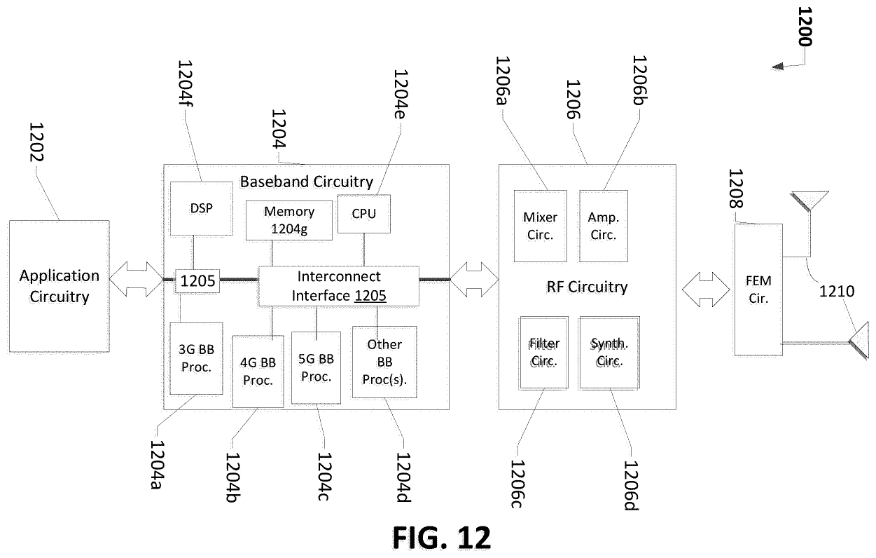

Referring to FIG. 12, a wireless communication device 1200 configured to use the inventive embodiment for HARQ methodologies, disclosed above, will now be described. As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

Embodiments described herein may be implemented into a system using any suitably configured hardware and/or software. FIG. 12 illustrates, for one embodiment, example components of an electronic device 1200. In embodiments, the electronic device 1200 may be, implement, be incorporated into, or otherwise be a part of a user equipment (UE) or a network access station such as an eNB or gNB. In some embodiments, electronic device 1200 may include application circuitry 1202, baseband circuitry 1204, Radio Frequency (RF) circuitry 1206, front-end module (FEM) circuitry 1208 and one or more antennas 1210, coupled together at least as shown. Electronic device 1200 may include interconnects (shown by arrows and dark lines) such as PCIe, Advanced eXtensible Interconnect (AXI) or open core protocol (OCP) or the like to exchange information and/or signals between a host, various peripherals or sub-peripherals, referred to as components. And each component communicating over the interconnect, must have an interface 1205 to do so.

The application circuitry 1202 may include one or more application processors or processing units. For example, the application circuitry 1202 may include circuitry such as, but not limited to, one or more single-core or multi-core processors 1202a. The processor(s) 1202a may include any combination of general-purpose processors and dedicated processors (e.g., graphics processors, application processors, etc.). The processors 1202a may be coupled with and/or may include computer-readable media 1202b (also referred to as “CRM 1202b”, “memory 1202b”, “storage 1202b”, or “memory/storage 1202b”) and may be configured to execute instructions stored in the CRM 1202b to enable various applications and/or operating systems to run on the system and/or enable features of the inventive embodiments to be enabled.

The baseband circuitry 1204 may include circuitry such as, but not limited to, one or more single-core or multi-core processors to arrange, configure, process, generate, transmit, receive, or otherwise determine time differences of carrier aggregation signals as described in various embodiments herein. The baseband circuitry 1204 may include one or more baseband processors and/or control logic to process baseband signals received from a receive signal path of the RF circuitry 1206 via an interconnect interface 1205 and to generate baseband signals for a transmit signal path of the RF circuitry 1206. Baseband circuitry 1204 may also interface 1205 via an interconnect, with the application circuitry 1202 for generation and processing of the baseband signals and for controlling operations of the RF circuitry 1206. For example, in some embodiments, the baseband circuitry 1204 may include a third generation (3G) baseband processor 1204a, a fourth generation (4G) baseband processor 1204b, a fifth generation (5G)/NR baseband processor 1204c, and/or other baseband processor(s) 1204d for other existing generations, generations in development or to be developed in the future (e.g., 6G, etc.). The baseband processing circuit 1204 (e.g., one or more of baseband processors 1204a-d) may handle various radio control functions that enable communication with one or more radio networks via the RF circuitry 1206. The radio control functions may include, but are not limited to, signal modulation/demodulation, encoding/decoding, radio frequency shifting, as well as measuring time difference between carrier aggregation signals as discussed previously. In some embodiments, modulation/demodulation circuitry of the baseband circuitry 1204 may include Fast-Fourier Transform (FFT), precoding, and/or constellation mapping/demapping functionality. In some embodiments, encoding/decoding circuitry of the baseband circuitry 1204 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1204 may include elements of a protocol stack such as, for example, elements of an evolved universal terrestrial radio access network (E-UTRAN) protocol including, for example, physical (PHY), media access control (MAC), radio link control (RLC), packet data convergence protocol (PDCP), and/or radio resource control (RRC) elements. A central processing unit (CPU) 1204e of the baseband circuitry 1204 may be configured to run elements of the protocol stack for signaling of the PHY, MAC, RLC, PDCP and/or RRC layers. In some embodiments, the baseband circuitry may include one or more digital signal processor(s) (DSP) 1204f for audio processing. The DSP(s) 1204f may include elements for compression/decompression and echo cancellation and may include other suitable processing elements in other embodiments. The baseband circuitry 1204 may further include computer-readable media 1204g (also referred to as “CRM 1204g”, “memory 1204g”, or “storage 1204g”). The CRM 1204g may be used to load and store data and/or instructions for operations performed by the processors of the baseband circuitry 1204. CRM 1204g for one embodiment may include any combination of suitable volatile memory and/or non-volatile memory. The CRM 1204g may include any combination of various levels of memory/storage including, but not limited to, read-only memory (ROM) having embedded software instructions (e.g., firmware), random access memory (e.g., dynamic random access memory (DRAM)), cache, buffers, etc.). The CRM 1204g may be shared among the various processors or dedicated to particular processors. Components of the baseband circuitry 1204 may be suitably combined in a single chip, a single chipset, or disposed on a same circuit board in some embodiments. In some embodiments, some or all of the constituent components of the baseband circuitry 1204 and the application circuitry 1202 may be implemented together, such as, for example, on a system on a chip (SOC).

In some embodiments, the baseband circuitry 1204 may provide for communication compatible with one or more radio technologies. For example, in some embodiments, the baseband circuitry 1204 may support communication with an E-UTRAN, NR and/or other wireless metropolitan area networks (WMAN), a wireless local area network (WLAN), a wireless personal area network (WPAN). Embodiments in which the baseband circuitry 1204 is configured to support radio communications of more than one wireless protocol may be referred to as multi-mode baseband circuitry.

RF circuitry 1206 may enable communication with wireless networks using modulated electromagnetic radiation through a non-solid medium. In various embodiments, the RF circuitry 1206 may include switches, filters, amplifiers, etc., to facilitate the communication with the wireless network. RF circuitry 1206 may include a receive signal path that may include circuitry to down-convert RF signals received from the FEM circuitry 1208 and provide baseband signals to the baseband circuitry 104. RF circuitry 1206 may also include a transmit signal path that may include circuitry to up-convert baseband signals provided by the baseband circuitry 1204 and provide RF output signals to the FEM circuitry 1208 for transmission.

In some embodiments, the RF circuitry 1206 may include a receive signal path and a transmit signal path. The receive signal path of the RF circuitry 1206 may include mixer circuitry 1206a, amplifier circuitry 1206b and filter circuitry 1206c. The transmit signal path of the RF circuitry 1206 may include filter circuitry 1206c and mixer circuitry 1206a. RF circuitry 1206 may also include synthesizer circuitry 1206d for synthesizing a frequency for use by the mixer circuitry 1206a of the receive signal path and the transmit signal path. In some embodiments, the mixer circuitry 1206a of the receive signal path may be configured to down-convert RF signals received from the FEM circuitry 1208 based on the synthesized frequency provided by synthesizer circuitry 1206d. The amplifier circuitry 1206b may be configured to amplify the down-converted signals and the filter circuitry 1206c may be a low-pass filter (LPF) or band-pass filter (BPF) configured to remove unwanted signals from the down-converted signals to generate output baseband signals. Output baseband signals may be provided to the baseband circuitry 1204 for further processing. In some embodiments, the output baseband signals may be zero-frequency baseband signals, although this is not a requirement. In some embodiments, mixer circuitry 1206a of the receive signal path may comprise passive mixers, although the scope of the embodiments is not limited in this respect.

In some embodiments, the mixer circuitry 1206a of the transmit signal path may be configured to up-convert input baseband signals via interconnect and based on the synthesized frequency provided by the synthesizer circuitry 1206d to generate RF output signals for the FEM circuitry 1208. The baseband signals may be provided by the baseband circuitry 1204 and may be filtered by filter circuitry 1206c. The filter circuitry 1206c may include a low-pass filter (LPF), although the scope of the embodiments is not limited in this respect.

In some embodiments, the mixer circuitry 1206a of the receive signal path and the mixer circuitry 1206a of the transmit signal path may include two or more mixers and may be arranged for quadrature downconversion and/or upconversion, respectively. In some embodiments, the mixer circuitry 1206a of the receive signal path and the mixer circuitry 1206a of the transmit signal path may include two or more mixers and may be arranged for image rejection (e.g., Hartley image rejection). In some embodiments, the mixer circuitry 1206a of the receive signal path and the mixer circuitry 1206a of the transmit signal path may be arranged for direct downconversion and/or direct upconversion, respectively. In some embodiments, the mixer circuitry 1206a of the receive signal path and the mixer circuitry 1206a of the transmit signal path may be configured for super-heterodyne operation.

In some embodiments, the output baseband signals and the input baseband signals may be analog baseband signals which are digitally converted to provide digital data to processors via interface 1205 to through the interconnect, although the scope of the embodiments is not limited in this respect. In some alternate embodiments, the output baseband signals and the input baseband signals may be digital baseband signals. In these alternate embodiments, the RF circuitry 1206 may include analog-to-digital converter (ADC) and digital-to-analog converter (DAC) circuitry and the baseband circuitry 1204 may include an RF interface 1205, such as an analog or digital baseband interface, to communicate with the RF circuitry 1206.

In dual-mode embodiments, a separate radio IC circuitry may be provided for processing signals for each spectrum, although the scope of the embodiments is not limited in this respect.

In some embodiments, the synthesizer circuitry 1206d may be a fractional-N synthesizer or a fractional N/N+1 synthesizer, although the scope of the embodiments is not limited in this respect, as other types of frequency synthesizers may be suitable. For example, synthesizer circuitry 1206d may be a delta-sigma synthesizer, a frequency multiplier, or a synthesizer comprising a phase-locked loop with a frequency divider. The synthesizer circuitry 1206d may be configured to synthesize an output frequency for use by the mixer circuitry 1206a of the RF circuitry 1206 based on a frequency input and a divider control input. In some embodiments, the synthesizer circuitry 1206d may be a fractional N/N+1 synthesizer.

In some embodiments, frequency input may be provided by a voltage controlled oscillator (VCO), although that is not a requirement. Divider control input may be provided by either the baseband circuitry 1204 or the application circuitry 1202 depending on the desired output frequency. In some embodiments, a divider control input (e.g., N) may be determined from a look-up table based on a channel indicated by the application circuitry 1202.

Synthesizer circuitry 1206d of the RF circuitry 1206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1206 may include an IQ/polar converter.

FEM circuitry 1208 may include a receive signal path that may include circuitry configured to operate on RF signals received from one or more antennas 1210, amplify the received signals and provide the amplified versions of the received signals to the RF circuitry 1206 for further processing. FEM circuitry 1208 may also include a transmit signal path that may include circuitry configured to amplify signals for transmission provided by the RF circuitry 1206 for transmission by one or more of the one or more antennas 1210. In some embodiments, the FEM circuitry 1208 may include a TX/RX switch to switch between transmit mode and receive mode operation. The FEM circuitry 1208 may include a receive signal path and a transmit signal path. The receive signal path of the FEM circuitry may include a low-noise amplifier (LNA) to amplify received RF signals and provide the amplified received RF signals as an output (e.g., to the RF circuitry 1206). The transmit signal path of the FEM circuitry 1208 may include a power amplifier (PA) to amplify input RF signals (e.g., provided by RF circuitry 1206), and one or more filters to generate RF signals for subsequent transmission (e.g., by one or more of the one or more antennas 1210).

In some embodiments, the electronic device 1200 may include additional elements such as, for example, a display, a camera, one or more sensors, and/or interface 1205 to interconnect (for example, input/output (I/O) interfaces or buses). In embodiments where the electronic device is implemented to provide networking functions such as an eNB or gNB, the electronic device 1200 may include network interface circuitry. The network interface circuitry may be one or more computer hardware components that connect electronic device 1200 to one or more network elements, such as one or more servers within a core network via one or more wired connections. To this end, the network interface circuitry may include one or more dedicated processors and/or field programmable gate arrays (FPGAs) to communicate using one or more network communications protocols such as X2 application protocol (AP), S1 AP, Stream Control Transmission Protocol (SCTP), Ethernet, Point-to-Point (PPP), Fiber Distributed Data Interface (FDDI), and/or any other suitable network communications protocols.

As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.” “Interface” may simply be a connector or bus wire through which signals are transferred, including one or more pins on an integrated circuit.

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

### Example Embodiments

According to a First Example embodiment, an apparatus is disclosed for a user equipment (UE) communication device to communicate in a wireless network

In a First Example embodiment, an apparatus for a user equipment (UE) communication device to communicate in a wireless network, the apparatus including a baseband processing circuit including one or more processors adapted to configure one or more code block groups (CBG) designating code blocks for retransmission, said code block groups configured according to a code block group index bitmap present in received downlink control information (DCI); and an interconnect interface coupled to the baseband processing unit and adapted to enable the one or more processors to communicate signals between at least one UE component selected from a group comprising: a dual band radio frequency (RF) transceiver, a memory circuit, an application processor and a digital signal processor (DSP), via an interconnect bus.

In a Second Example, the First is furthered wherein the CBG index is provided in said DCI by a new radio (NR) NodeB (gNB).

In a Third Example embodiment, the Second or First Examples are further defined by each bit in the bitmap indicates whether a CBG is retransmitted.

According to a Fourth Example embodiment, the First Example is further exapanded by the baseband processor being adapted to configure a number of CBGs, and wherein for all transport blocks (TBs) with a number of code blocks (CBs) larger than the number of configured CBGs, the CBs are grouped into the configured number of CBGs.

In a Fifth Example, any of the prior examples may be further defined wherein the baseband processor is adapted to configure a number of CBGs, and wherein for all transport blocks (TBs) with a number of CBs smaller than the number of CBGs, only a single CBG is used based on a transport block size (TBS) value; and wherein when the number of CBs is greater than or equal to the number of configured CBGs, the CBs are grouped into CBGs substantially uniformly.

A Sixth Example furthers the First Example, wherein the CBG index bitmap is not included for DCI scheduling initial data transmission, and wherein zero padding is inserted in place of the CBG index bitmap.

A Seventh Example furthers any of the prior examples wherein a maximum number of CBGs (N) is predefined or configured by higher layers via at least one of a NR master information block (MIB), NR remaining master information block (MMIB), NR system information block (SIB) or radio resource control (RRC) signaling.

In an Eighth Example, any of the prior examples may further include a bit order of the CGG index bitmap in the DCI indicates an index for retransmission.

A Ninth Example furthers any of the prior examples wherein a number of Hybrid automatic repeat request-acknowledgement (HARQ-ACK) feedback bits is determined according to a number of scheduled CBGs for both initial transmission and retransmission.

In a Tenth Example, a device for a wireless communication device to communicate in a wireless network includes: a processing circuit configured to provide downlink control information (DCI) to schedule transmissions for one or more mobile devices; and a network interface adapted to provide mobile user connectivity to a core Internet Protocol (IP) network; wherein the processing circuit generates downlink control information (DCI) including a bitmap index for code block groups (CBGs) to be used by user equipment (UE) for retransmission requests.

In an Eleventh Example, the Tenth Example is furthered by the index indicating to the UE to configure a number of CBGs, and wherein for all transport blocks (TBs) with a number of CBs smaller than the number of CBGs, only a single CBG is used based on a transport block size (TBS) value; and wherein when the number of CBs is greater than or equal to the number of configured CBGs, the CBs are grouped into CBGs substantially uniformly.

According to a Twelfth Example, the Tenth is furthered by the CBG bitmap index is not being included for DCI scheduling initial data transmission, and zero padding is inserted in place of the CBG index bitmap.

In a Thirteenth Example, the Tenth is furthered by a maximum number of CBGs (N) is predefined or configured by the processing circuit for sending to a UE via at least one of a NR master information block (MIB), NR remaining master information block (MMIB), NR system information block (SIB) or radio resource control (RRC) signaling.

In a Fourteenth Example, any of the prior examples may further be defined by a bit order of the CBG index bitmap in the DCI indicating an index for retransmission.

In a Fifteenth Example, any of the prior examples my be furthered by a bit ordering of HARQ-ACK feedback for CBG based retransmission following the CBG bitmap index in the DCI scheduling retransmission.

According to a Sixteenth Example, the Tenth through the Thirteenth examples, may be furthered by bit ordering of HARQ-ACK feedback for CBG based retransmission beginning from a 1st bit.

A Seventeenth Example may further the Tenth through the Thirteenth, wherein when both semi-static and dynamic HARQ-ACK payload size determination are supported for CBG based retransmission, HARQ-ACK payload size determination is selected by the processing circuit and provided to UEs via higher layers via NR MIB, NR MMIB, NR SIB or RRC signaling.

In an Eighteenth Example embodiment, a computer-readable medium is disclosed which stores executable instructions that, in response to execution, cause one or more processors of a baseband processing circuit of a user equipment (UE), to perform operations including: configuring one or more code block groups (CBG) designating code blocks for retransmission, said code block groups configured according to a code block group index bitmap present in received downlink control information (DCI); and transmitting CBGs according to the index bitmap.

A Nineteenth Example furthers the Eighteenth wherein a maximum number of CBGs (N) is predefined or configured from downlink control information from at least one of a NR master information block (MIB), NR remaining master information block (MMIB), NR system information block (SIB) or radio resource control (RRC) signaling.

In a Twentieth Example, the prior two examples may be furthered wherein a bit order of the CBG index bitmap in the DCI indicates an index for retransmission.

A Twenty-First Example embodiments furthers the Eighteenth through Twentieth Examples, by a bit ordering of HARQ-ACK feedback for CBG based retransmission follows the CBG bitmap index in the DCI scheduling retransmission.

A Twenty-Second Example embodiment may further the prior examples wherein bit ordering of HARQ-ACK feedback for CBG based retransmission begins from a 1st bit.

A Twenty-Third Example may further define any one of the prior examples wherein the CBG bitmap index is not included for DCI scheduling initial data transmission, and wherein zero padding is inserted in place of the CBG index bitmap.

In a Twenty-Fourth Example, any of the previous embodiments may be implemented as means for performing various steps in the HARQ signaling embodiments described herein.

Moreover, in a Twenty-Fifth Example, a UE may determine whether or not a CBG is retransmitted by a gNB, after the UE has provided ACK or NACK feedback of receipt of a CBG, based on a corresponding value of the original bitmap index indicating the CBGs being transmitted. For example, the UE may determine that a CBG is being retransmitted based on a corresponding value of the CBGTI field where a “0” indicates a corresponding CBG is being retransmitted, and wherein a “1” indicates that a corresponding CBG is not retransmitted.

In a Twenty-Sixth Example, a method/device/or computer readable medium may, if the UE is configured by higher layer parameters with HARQ-ACK-codebook=semi-static, the HARQ-ACK codebook includes CBG per TB maximum HARQ-ACK information bits, wherein if the actual CBG per TB used is less than the maximum, the UE is configured to generate a NACK value for the last HARQ-ACK information bits to fill unneeded bit values in the maximum CBG per TB field specified by the codebook.

Additional Example embodiments are as follows:

A method/device/circuit for wireless communication including receiving, by the UE, one or more transport blocks within a subframe; and selecting, by the UE, to perform skip-decoding of at least one transport block of the one or more blocks received in the said time window based, at least in part, on the data channel type and total transport block size (TBS).

Another Example embodiment may improve over the prior embodiment wherein the data channel type comprises one of a Physical Downlink Shared Channel (PDSCH) using 1 ms Transmission Time Interval (TTI) length; and A shortened PDSCH (sPDSCH) using shortened TTI (sTTI) comprising less number of OFDM symbols than that in a 1 ms TTI.

Any of the prior two examples may be furthered wherein the UE selects to perform the skip-decoding one PDSCH channel when the received data channel type in the subframe comprises a shortened sPDSCH.

Another example furthers any of the previous examples wherein the UE selects to not perform the skip-decoding when the data channel type in the subframe comprises the PDSCH transmission.

In yet another example, the UE is configured to monitor for the sPDSCH and PDSCH. And even a further example of the prior examples includes selecting to perform a skip-decoding is further based, at least in part, on total TBS of PDSCH and sPDSCH received by the UE in the time window exceeds a TBS threshold.

Another embodiment includes wherein the skip-decoding comprise one or more of: delaying a hybrid automatic repeat request (HARQ) acknowledgement (ACK) decision or set “NACK”; skipping all decoding of the one or more transport blocks; and attempting to decode the one or more transport blocks using a best-efforts approach. In some examples, the UE performs a HARQ-ACK timing or sPUSCH scheduling timing determination based on at least part of a maximum timing advance threshold.

In one example embodiment a larger HARQ-ACK timing or sPUSCH scheduling timing is used if the maximum TA value is up to a predefine value T1; and a smaller HARQ-ACK timing or sPUSCH scheduling timing is used if the maximum TA value is up to a predefine value T2, T1>T2.

In yet another example embodiment, the time window size is determined at least in part based on the HARQ-ACK timeline of PDSCH channel with longer TTI length. A further example selectively determines whether to individually apply a skip-decoding decision to a respective PDSCH based on the scheduling subframe within the decoding window. The UE may perform soft buffer management by storing soft bits received in the subframe in which UE skipped PDSCH decoding within the time window.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The present disclosure has been described with reference to the attached drawing figures, with certain example terms and wherein like reference numerals are used to refer to like elements throughout. The illustrated structures, devices and methods are not intended to be drawn to scale, or as any specific circuit or any in any way other than as functional block diagrams to illustrate certain features, advantages and enabling disclosure of the inventive embodiments and their illustration and description is not intended to be limiting in any manner in respect to the appended claims that follow, with the exception of 35 USC 112, sixth paragraph, claims using the literal words “means for,” if present in a claim. As utilized herein, the terms “component,” “system,” “interface,” “logic,” “circuit,” “device,” and the like are intended only to refer to a basic functional entity such as hardware, processor designs, software (e.g., in execution), logic (circuits or programmable), firmware alone or in combination to suit the claimed functionalities. For example, a component, module, circuit, device or processing unit “configured to,” “adapted to” or “arranged to” may mean a microprocessor, a controller, a programmable logic array and/or a circuit coupled thereto or other logic processing device, and a method or process may mean instructions running on a processor, firmware programmed in a controller, an object, an executable, a program, a storage device including instructions to be executed, a computer, a tablet PC and/or a mobile phone with a processing device. By way of illustration, a process, logic, method or module can be any analog circuit, digital processing circuit or combination thereof. One or more circuits or modules can reside within a process, and a module can be localized as a physical circuit, a programmable array, a processor. Furthermore, elements, circuits, components, modules and processes/methods may be hardware or software, combined with a processor, executable from various computer readable storage media having executable instructions and/or data stored thereon. Those of ordinary skill in the art will recognize various ways to implement the logical descriptions of the appended claims and their interpretation should not be limited to any example or enabling description, depiction or layout described above, in the abstract or in the drawing figures.

1-23. (canceled)

24. An apparatus for a user equipment (UE) communication device to communicate in a wireless network, the apparatus comprising:
a baseband processing circuit including one or more processors adapted to configure one or more code block groups (CBG) designating code blocks for retransmission, said code block groups configured according to a code block group index bitmap present in received downlink control information (DCI); and
an interconnect interface coupled to the baseband processing unit and adapted to enable the one or more processors to communicate signals between at least one UE component selected from a group comprising: a dual band radio frequency (RF) transceiver, a memory circuit, an application processor and a digital signal processor (DSP), via an interconnect bus.

25. The apparatus of claim 24, wherein the baseband processor is adapted to configure a number of CBGs, and wherein for all transport blocks (TBs) with a number of code blocks (CBs) larger than the number of configured CBGs, the CBs are grouped into the configured number of CBGs.

26. The apparatus of claim 24, wherein the baseband processor is adapted to configure a number of CBGs, and wherein for all transport blocks (TBs) with a number of CBs smaller than the number of CBGs, only a single CBG is used based on a transport block size (TBS) value; and wherein when the number of CBs is greater than or equal to the number of configured CBGs, the CBs are grouped into CBGs substantially uniformly.

27. The apparatus of claim 24, wherein the CBG index bitmap is not included for DCI scheduling initial data transmission, and wherein zero padding is inserted in place of the CBG index bitmap.

28. The apparatus of claim 24, wherein a maximum number of CBGs (N) is predefined or configured by higher layers via at least one of a NR master information block (MIB), NR remaining master information block (MMIB), NR system information block (SIB) or radio resource control (RRC) signaling.

29. The apparatus of claim 24, wherein a bit order of the CGG index bitmap in the DCI indicates an index for retransmission.

30. The apparatus of claim 24, wherein a number of Hybrid automatic repeat request-acknowledgement (HARQ-ACK) feedback bits is determined according to a number of scheduled CBGs for both initial transmission and retransmission.

31. A device for a wireless communication device to communicate in a wireless network, the device comprising:
a processing circuit configured to provide downlink control information (DCI) to schedule transmissions for one or more mobile devices; and
an network interface adapted to provide mobile user connectivity to a core Internet Protocol (IP) network; wherein the processing circuit generates downlink control information (DCI) including a bitmap index for code block groups (CBGs) to be used by user equipment (UE) for retransmission requests.

32. The device of claim 31, wherein the index indicates to the UE to configure a number of CBGs, and wherein for all transport blocks (TBs) with a number of CBs smaller than the number of CBGs, only a single CBG is used based on a transport block size (TBS) value; and wherein when the number of CBs is greater than or equal to the number of configured CBGs, the CBs are grouped into CBGs substantially uniformly.

33. The device of claim 31, wherein the CBG bitmap index is not included for DCI scheduling initial data transmission, and zero padding is inserted in place of the CBG index bitmap.

34. The device of claim 31, wherein a maximum number of CBGs (N) is predefined or configured by the processing circuit for sending to a UE via at least one of a NR master information block (MIB), NR remaining master information block (MMIB), NR system information block (SIB) or radio resource control (RRC) signaling.

35. The device of claim 31, wherein a bit order of the CBG index bitmap in the DCI indicates an index for retransmission.

36. The device of claim 31, wherein a bit ordering of HARQ-ACK feedback for CBG based retransmission follows the CBG bitmap index in the DCI scheduling retransmission.

37. The device of claim 31, wherein bit ordering of HARQ-ACK feedback for CBG based retransmission begins from a 1st bit.

38. A non-transitory computer-readable medium storing executable instructions that, in response to execution, cause one or more processors of a baseband processing circuit of a user equipment (UE), to perform operations comprising:
configuring one or more code block groups (CBG) designating code blocks for retransmission, said code block groups configured according to a code block group index bitmap present in received downlink control information (DCI);
transmitting CBGs according to the index bitmap.

39. The non-transitory computer-readable medium of claim 38, wherein a maximum number of CBGs (N) is predefined or configured from downlink control information from at least one of a NR master information block (MIB), NR remaining master information block (MMIB), NR system information block (SIB) or radio resource control (RRC) signaling.

40. The non-transitory computer-readable medium of claim 38, wherein a bit order of the CBG index bitmap in the DCI indicates an index for retransmission.

41. The non-transitory computer-readable medium of claim 38, wherein a bit ordering of HARQ-ACK feedback for CBG based retransmission follows the CBG bitmap index in the DCI scheduling retransmission.

42. The non-transitory computer-readable medium of claim 38, wherein bit ordering of HARQ-ACK feedback for CBG based retransmission begins from a 1st bit.

43. The non-transitory computer-readable medium of claim 38, wherein the CBG bitmap index is not included for DCI scheduling initial data transmission, and wherein zero padding is inserted in place of the CBG index bitmap.
